(19) United States
(12) Patent Application Publication
(10) Pub. No.: US 2015/0300993 A1
(43) Pub. Date: Oct. 22, 2015

(54) ULTRASONIC INSPECTION

(71) Applicants: Christopher D. Prest, San Francisco, CA (US); Matthew S. Scott, San Jose, CA (US); Stephen P. Zadesky, Portola Valley, CA (US); Richard W. Heley, Palo Alto, CA (US); Dermot J. Stratton, San Francisco, CA (US); Joseph C. Poole, San Francisco, CA (US); Theodore Andrew Waniuk, Lake Forest, CA (US)

(72) Inventors: Christopher D. Prest, San Francisco, CA (US); Matthew S. Scott, San Jose, CA (US); Stephen P. Zadesky, Portola Valley, CA (US); Richard W. Heley, Palo Alto, CA (US); Dermot J. Stratton, San Francisco, CA (US); Joseph C. Poole, San Francisco, CA (US); Theodore Andrew Waniuk, Lake Forest, CA (US)

(21) Appl. No.: 14/396,283

(22) PCT Filed: Apr. 24, 2012
(86) PCT No.: PCT/US2012/034811

§ 371 Date: Jan. 14, 2015

(51) Int. Cl. G01N 29/26; C22C 1/00; C22C 45/02; C21D 1/18; C22C 45/10; C22F 1/00; C22F 1/14; C22F 1/18; G01N 29/12; C22C 45/00

(52) U.S. Cl. CPC G01N 29/26; G01N 29/12; C22C 1/002; C22C 45/02; C22C 45/003; C22C 45/10; C22F 1/002; C22F 1/14; C22F 1/186; C21D 1/18; G01N 2291/0234; G01N 2291/0232; G01N 2291/02827; G01N 2291/10

(57) ABSTRACT

One embodiment provides a method comprising: providing a sample comprising a bulk amorphous alloy; scanning ultrasonically at least a portion of the sample to determine a parameter of the sample in the portion; and comparing the parameter to a predetermined standard to derive a property related to the sample.

All publications, patents, and patent applications cited in this Specification are hereby incorporated by reference in their entirety.

### BACKGROUND

A large portion of the metallic alloys in use today are processed by solidification casting, at least initially. The metallic alloy is melted and cast into a metal or ceramic mold, where it solidifies. The mold is stripped away, and the cast metallic piece is ready for use or further processing. The as-cast structure of most materials produced during solidification and cooling depends upon the cooling rate. There is no general rule for the nature of the variation, but for the most part the structure changes only gradually with changes in cooling rate. On the other hand, for the bulk-solidifying amorphous alloys, the change between the amorphous state produced by relatively rapid cooling and the crystalline state produced by relatively slower cooling is one of kind rather than degree—the two states have distinct properties.

Bulk-solidifying amorphous alloys, or bulk metallic glasses (“BMG”), are a recently developed class of metallic materials. These alloys may be solidified and cooled at relatively slow rates, and they retain the amorphous, non-crystalline (i.e., glassy) state at room temperature. Amorphous alloys have many superior properties than their crystalline counterparts. However, if the cooling rate is not sufficiently high, crystals may form inside the alloy during cooling, so that the benefits of the amorphous state can be lost. For example, one challenge with the fabrication of bulk amorphous alloy parts is partial crystallization of the parts due to either slow cooling or impurities in the raw alloy material. Thus, ensuring a high degree of amorphicity (and, conversely, a low degree of crystallinity) can be important in the quality control of a BMG fabrication process.

Currently, the methods to detect the presence of a crystalline phase or to measure the degree of crystallinity can include bending test, x-ray radiography, and etching. However, all of these pre-existing techniques are destructive to the specimens examined. As a result, a BMG part (e.g., a casing) that is to be examined first needs to be significantly altered (e.g., sectioned and/or ground to a powder form), which can be undesirable.

Thus, a need exists to develop methods that can determine the degree of crystallinity of a BMG non-destructively, whereby facilitating quality control of its fabrication process.

### SUMMARY

Some embodiments provided herein are related to nondestructive testing of materials using ultrasonic inspection techniques, such as resonant ultrasound spectroscopy (RUS).

One embodiment provides a method, comprising: providing a sample comprising a bulk amorphous alloy; scanning ultrasonically at least a portion of the sample to determine a parameter of the sample in the portion; and comparing the parameter to a predetermined standard to derive a property related to the sample.

An alternative embodiment provides a method, comprising: obtaining at least one standard parameter from at least one standard alloy sample by scanning ultrasonically the at least one standard alloy sample; obtaining a test parameter from a test alloy sample comprising a bulk amorphous alloy by scanning ultrasonically the test alloy sample; and evaluating the test alloy sample by comparing the standard parameter with the test parameter.

Another embodiment provides an apparatus that is configured to carry out the method comprising: scanning ultrasonically at least a portion of a sample comprising a bulk amorphous alloy to determine a parameter of the sample in the portion; and comparing the parameter to a predetermined standard to derive a property related to the sample.

### BRIEF DESCRIPTION OF THE DRAWINGS

FIG. 1 provides a temperature-viscosity diagram of an exemplary bulk solidifying amorphous alloy.

FIG. 2 provides a schematic of a time-temperature-transformation (TTT) diagram for an exemplary bulk solidifying amorphous alloy.

FIG. 3 provides a schematic of an apparatus for applying ultrasonic excitations and for measuring the material responses to the excitations in one embodiment.

FIG. 4 provides a schematic of an apparatus for applying ultrasonic excitations to materials and for measuring contactless the response in one embodiment.

FIG. 5 illustrates a flow chart showing an inspection process in one embodiment.

FIG. 6 shows an illustrative example of a database storing responses of BMG samples to ultrasonic excitations in one embodiment.

### DETAILED DESCRIPTION

11 publications, patents, and patent applications cited in this Specification are hereby incorporated by reference in their entirety.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Bulk-solidifying amorphous alloys, or bulk metallic glasses (“BMG”), are a recently developed class of metallic materials. These alloys may be solidified and cooled at relatively slow rates, and they retain the amorphous, non-crystalline (i.e., glassy) state at room temperature. Amorphous alloys have many superior properties than their crystalline counterparts. However, if the cooling rate is not sufficiently high, crystals may form inside the alloy during cooling, so that the benefits of the amorphous state can be lost. For example, one challenge with the fabrication of bulk amorphous alloy parts is partial crystallization of the parts due to either slow cooling or impurities in the raw alloy material. As a high degree of amorphicity (and, conversely, a low degree of crystallinity) is desirable in BMG parts, there is a need to develop methods for casting BMG parts having controlled amount of amorphicity.

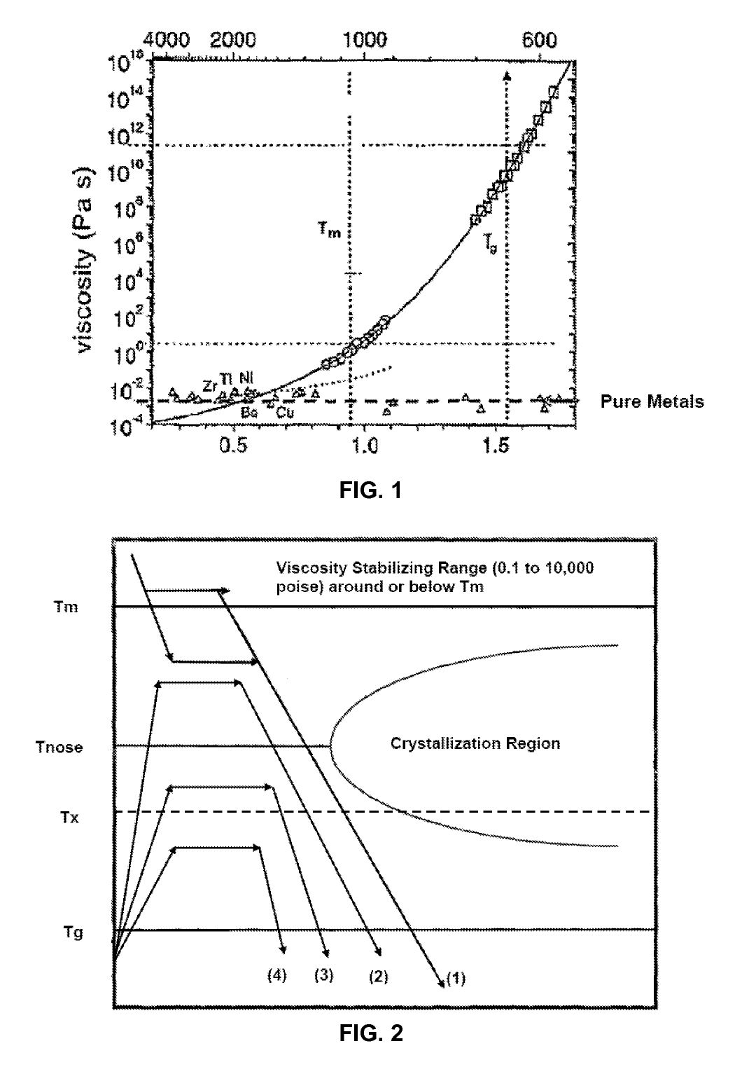

FIG. 1 (obtained from U.S. Pat. No. 7,575,040) shows a viscosity-temperature graph of an exemplary bulk solidifying amorphous alloy, from the VIT-001 series of Zr—Ti—Ni—Cu—Be family manufactured by Liquidmetal Technology. It should be noted that there is no clear liquid/solid transformation for a bulk solidifying amorphous metal during the formation of an amorphous solid. The molten alloy becomes more and more viscous with increasing undercooling until it approaches solid form around the glass transition temperature. Accordingly, the temperature of solidification front for bulk solidifying amorphous alloys can be around glass transition temperature, where the alloy will practically act as a solid for the purposes of pulling out the quenched amorphous sheet product.

FIG. 2 (obtained from U.S. Pat. No. 7,575,040) shows the time-temperature-transformation (TTT) cooling curve of an exemplary bulk solidifying amorphous alloy, or TTT diagram. Bulk-solidifying amorphous metals do not experience a liquid/solid crystallization transformation upon cooling, as with conventional metals. Instead, the highly fluid, non crystalline form of the metal found at high temperatures (near a “melting temperature” Tm) becomes more viscous as the temperature is reduced (near to the glass transition temperature Tg), eventually taking on the outward physical properties of a conventional solid.

Even though there is no liquid/crystallization transformation for a bulk solidifying amorphous metal, a “melting temperature” Tm may be defined as the thermodynamic liquidus temperature of the corresponding crystalline phase. Under this regime, the viscosity of bulk-solidifying amorphous alloys at the melting temperature could lie in the range of about 0.1 poise to about 10,000 poise, and even sometimes under 0.01 poise. A lower viscosity at the “melting temperature” would provide faster and complete filling of intricate portions of the shell/mold with a bulk solidifying amorphous metal for forming the BMG parts. Furthermore, the cooling rate of the molten metal to form a BMG part has to such that the time-temperature profile during cooling does not traverse through the nose-shaped region bounding the crystallized region in the TTT diagram of FIG. 2. In FIG. 2, Tnose is the critical crystallization temperature Tx where crystallization is most rapid and occurs in the shortest time scale.

The supercooled liquid region, the temperature region between Tg and Tx is a manifestation of the extraordinary stability against crystallization of bulk solidification alloys. In this temperature region the bulk solidifying alloy can exist as a high viscous liquid. The viscosity of the bulk solidifying alloy in the supercooled liquid region can vary between 10¹² Pa s at the glass transition temperature down to 10⁵ Pa s at the crystallization temperature, the high temperature limit of the supercooled liquid region. Liquids with such viscosities can undergo substantial plastic strain under an applied pressure. The embodiments herein make use of the large plastic formability in the supercooled liquid region as a forming and separating method.

One needs to clarify something about Tx. Technically, the nose-shaped curve shown in the TTT diagram describes Tx as a function of temperature and time. Thus, regardless of the trajectory that one takes while heating or cooling a metal alloy, when one hits the TTT curve, one has reached Tx. In FIG. 2, Tx is shown as a dashed line as Tx can vary from close to Tm to close to Tg.

The schematic TTT diagram of FIG. 2 shows processing methods of die casting from at or above Tm to below Tg without the time-temperature trajectory (shown as (1) as an example trajectory) hitting the TTT curve. During die casting, the forming takes place substeantially simultaneously with fast cooling to avoid the trajectory hitting the TTT curve. The processing methods for superplastic forming (SPF) from at or below Tg to below Tm without the time-temperature trajectory (shown as (2), (3) and (4) as example trajectories) hitting the TTT curve. In SPF, the amorphous BMG is reheated into the supercooled liquid region where the available processing window could be much larger than die casting, resulting in better controllability of the process. The SPF process does not require fast cooling to avoid crystallization during cooling. Also, as shown by example trajectories (2), (3) and (4), the SPF can be carried out with the highest temperature during SPF being above Tnose or below Tnose, up to about Tm. If one heats up a piece of amorphous alloy but manages to avoid hitting the TTT curve, you have heated “between Tg and Tm”, but one would have not reached Tx.

Typical differential scanning calorimeter (DSC) heating curves of bulk-solidifying amorphous alloys taken at a heating rate of 20 C/min describe, for the most part, a particular trajectory across the TTT data where one would likely see a Tg at a certain temperature, a Tx when the DSC heating ramp crosses the TTT crystallization onset, and eventually melting peaks when the same trajectory crosses the temperature range for melting. If one heats a bulk-solidifying amorphous alloy at a rapid heating rate as shown by the ramp up portion of trajectories (2), (3) and (4) in FIG. 2, then one could avoid the TTT curve entirely, and the DSC data would show a glass transition but no Tx upon heating. Another way to think about it is trajectories (2), (3) and (4) can fall anywhere in temperature between the nose of the TTT curve (and even above it) and the Tg line, as long as it does not hit the crystallization curve. That just means that the horizontal plateau in trajectories might get much shorter as one increases the processing temperature.

### Phase

The term “phase” herein can refer to one that can be found in a thermodynamic phase diagram. A phase is a region of space (e.g., a thermodynamic system) throughout which all physical properties of a material are essentially uniform. Examples of physical properties include density, index of refraction, chemical composition and lattice periodicity. A simple description of a phase is a region of material that is chemically uniform, physically distinct, and/or mechanically separable. For example, in a system consisting of ice and water in a glass jar, the ice cubes are one phase, the water is a second phase, and the humid air over the water is a third phase. The glass of the jar is another separate phase. A phase can refer to a solid solution, which can be a binary, tertiary, quaternary, or more, solution, or a compound, such as an intermetallic compound. As another example, an amorphous phase is distinct from a crystalline phase.

### Metal, Transition Metal, and Non-Metal

The term “metal” refers to an electropositive chemical element. The term “element” in this Specification refers generally to an element that can be found in a Periodic Table. Physically, a metal atom in the ground state contains a partially filled band with an empty state close to an occupied state. The term “transition metal” is any of the metallic elements within Groups 3 to 12 in the Periodic Table that have an incomplete inner electron shell and that serve as transitional links between the most and the least electropositive in a series of elements. Transition metals are characterized by multiple valences, colored compounds, and the ability to form stable complex ions. The term “nonmetal” refers to a chemical element that does not have the capacity to lose electrons and form a positive ion.

Depending on the application, any suitable nonmetal elements, or their combinations, can be used. The alloy (or “alloy composition”) can comprise multiple nonmetal elements, such as at least two, at least three, at least four, or more, nonmetal elements. A nonmetal element can be any element that is found in Groups 13-17 in the Periodic Table. For example, a nonmetal element can be any one of F, Cl, Br, I, At, O, S, Se, Te, Po, N, P, As, Sb, Bi, C, Si, Ge, Sn, Pb, and B. Occasionally, a nonmetal element can also refer to certain metalloids (e.g., B, Si, Ge, As, Sb, Te, and Po) in Groups 13-17. In one embodiment, the nonmetal elements can include B, Si, C, P, or combinations thereof. Accordingly, for example, the alloy can comprise a boride, a carbide, or both.

A transition metal element can be any of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, has sium, meitnerium, ununnilium, unununium, and ununbium. In one embodiment, a BMG containing a transition metal element can have at least one of Sc, Y, La, Ac, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, and Hg. Depending on the application, any suitable transitional metal elements, or their combinations, can be used. The alloy composition can comprise multiple transitional metal elements, such as at least two, at least three, at least four, or more, transitional metal elements.

The presently described alloy or alloy “sample” or “specimen” alloy can have any shape or size. For example, the alloy can have a shape of a particulate, which can have a shape such as spherical, ellipsoid, wire-like, rod-like, sheet-like, flake-like, or an irregular shape. The particulate can have any size. For example, it can have an average diameter of between about 1 micron and about 100 microns, such as between about 5 microns and about 80 microns, such as between about 10 microns and about 60 microns, such as between about 15 microns and about 50 microns, such as between about 15 microns and about 45 microns, such as between about 20 microns and about 40 microns, such as between about 25 microns and about 35 microns. For example, in one embodiment, the average diameter of the particulate is between about 25 microns and about 44 microns. In some embodiments, smaller particulates, such as those in the nanometer range, or larger particulates, such as those bigger than 100 microns, can be used.

The alloy sample or specimen can also be of a much larger dimension. For example, it can be a bulk structural component, such as an ingot, housing/casing of an electronic device or even a portion of a structural component that has dimensions in the millimeter, centimeter, or meter range.

### Solid Solution

The term “solid solution” refers to a solid form of a solution. The term “solution” refers to a mixture of two or more substances, which may be solids, liquids, gases, or a combination of these. The mixture can be homogeneous or heterogeneous. The term “mixture” is a composition of two or more substances that are combined with each other and are generally capable of being separated. Generally, the two or more substances are not chemically combined with each other.

### Alloy

In some embodiments, the alloy composition described herein can be fully alloyed. In one embodiment, an “alloy” refers to a homogeneous mixture or solid solution of two or more metals, the atoms of one replacing or occupying interstitial positions between the atoms of the other; for example, brass is an alloy of zinc and copper. An alloy, in contrast to a composite, can refer to a partial or complete solid solution of one or more elements in a metal matrix, such as one or more compounds in a metallic matrix. The term alloy herein can refer to both a complete solid solution alloy that can give single solid phase microstructure and a partial solution that can give two or more phases. An alloy composition described herein can refer to one comprising an alloy or one comprising an alloy-containing composite.

Thus, a fully alloyed alloy can have a homogenous distribution of the constituents, be it a solid solution phase, a compound phase, or both. The term “fully alloyed” used herein can account for minor variations within the error tolerance. For example, it can refer to at least 90% alloyed, such as at least 95% alloyed, such as at least 99% alloyed, such as at least 99.5% alloyed, such as at least 99.9% alloyed. The percentage herein can refer to either volume percent or weight percentage, depending on the context. These percentages can be balanced by impurities, which can be in terms of composition or phases that are not a part of the alloy.

### Amorphous or Non-Crystalline Solid

An “amorphous” or “non-crystalline solid” is a solid that lacks lattice periodicity, which is characteristic of a crystal. As used herein, an “amorphous solid” includes “glass” which is an amorphous solid that softens and transforms into a liquid-like state upon heating through the glass transition. Generally, amorphous materials lack the long-range order characteristic of a crystal, though they can possess some short-range order at the atomic length scale due to the nature of chemical bonding. The distinction between amorphous solids and crystalline solids can be made based on lattice periodicity as determined by structural characterization techniques such as x-ray diffraction and transmission electron microscopy.

The terms “order” and “disorder” designate the presence or absence of some symmetry or correlation in a many-particle system. The terms “long-range order” and “short-range order” distinguish order in materials based on length scales.

The strictest form of order in a solid is lattice periodicity: a certain pattern (the arrangement of atoms in a unit cell) is repeated again and again to form a translationally invariant tiling of space. This is the defining property of a crystal. Possible symmetries have been classified in 14 Bravais lattices and 230 space groups.

Lattice periodicity implies long-range order. If only one unit cell is known, then by virtue of the translational symmetry it is possible to accurately predict all atomic positions at arbitrary distances. The converse is generally true, except, for example, in quasi-crystals that have perfectly deterministic tilings but do not possess lattice periodicity.

Long-range order characterizes physical systems in which remote portions of the same sample exhibit correlated behavior. This can be expressed as a correlation function, namely the spin-spin correlation function: G(x,x′)= [symbol] s(x),s(x′) [symbol] .

In the above function, s is the spin quantum number and x is the distance function within the particular system. This function is equal to unity when x=x′ and decreases as the distance |x−x′| increases. Typically, it decays exponentially to zero at large distances, and the system is considered to be disordered. If, however, the correlation function decays to a constant value at large |x−x′|, then the system can be said to possess long-range order. If it decays to zero as a power of the distance, then it can be called quasi-long-range order. Note that what constitutes a large value of |x−x′| is relative.

A system can be said to present quenched disorder when some parameters defining its behavior are random variables that do not evolve with time (i.e., they are quenched or frozen)—e.g., spin glasses. It is opposite to annealed disorder, where the random variables are allowed to evolve themselves. Embodiments herein include systems comprising quenched disorder.

The alloy described herein can be crystalline, partially crystalline, amorphous, or substantially amorphous. For example, the alloy sample/specimen can include at least some crystallinity, with grains/crystals having sizes in the nanometer and/or micrometer ranges. Alternatively, the alloy can be substantially amorphous, such as fully amorphous. In one embodiment, the alloy composition is at least substantially not amorphous, such as being substantially crystalline, such as being entirely crystalline.

In one embodiment, the presence of a crystal or a plurality of crystals in an otherwise amorphous alloy can be construed as a “crystalline phase” therein. The degree of crystallinity (or “crystallinity” for short in some embodiments) of an alloy can refer to the amount of the crystalline phase present in the alloy. The degree can refer to, for example, a fraction of crystals present in the alloy. The fraction can refer to volume fraction or weight fraction, depending on the context. A measure of how “amorphous” an amorphous alloy is can be amorphicity. Amorphicity can be measured in terms of a degree of crystallinity. For example, in one embodiment, an alloy having a low degree of crystallinity can be said to have a high degree of amorphicity. In one embodiment, for example, an alloy having 60 vol % crystalline phase can have a 40 vol % amorphous phase.

### Amorphous Alloy or Amorphous Metal

An “amorphous alloy” is an alloy having an amorphous content of more than 50% by volume, preferably more than 90% by volume of amorphous content, more preferably more than 95% by volume of amorphous content, and most preferably more than 99% to almost 100% by volume of amorphous content. Note that, as described above, an alloy high in amorphicity is equivalently low in degree of crystallinity. An “amorphous metal” is an amorphous metal material with a disordered atomic-scale structure. In contrast to most metals, which are crystalline and therefore have a highly ordered arrangement of atoms, amorphous alloys are non-crystalline. Materials in which such a disordered structure is produced directly from the liquid state during cooling are sometimes referred to as “glasses.” Accordingly, amorphous metals are commonly referred to as “metallic glasses” or “glassy metals.” In one embodiment, a bulk metallic glass (“BMG”) can refer to an alloy, of which the microstructure is at least partially amorphous. However, there are several ways besides extremely rapid cooling to produce amorphous metals, including physical vapor deposition, solid-state reaction, ion irradiation, melt spinning, and mechanical alloying. Amorphous alloys can be a single class of materials, regardless of how they are prepared.

Amorphous metals can be produced through a variety of quick-cooling methods. For instance, amorphous metals can be produced by sputtering molten metal onto a spinning metal disk. The rapid cooling, on the order of millions of degrees a second, can be too fast for crystals to form, and the material is thus “locked in” a glassy state. Also, amorphous metals/alloys can be produced with critical cooling rates low enough to allow formation of amorphous structures in thick layers—e.g., bulk metallic glasses.

The terms “bulk metallic glass” (“BMG”), bulk amorphous alloy (“BAA”), and bulk solidifying amorphous alloy are used interchangeably herein. They refer to amorphous alloys having the smallest dimension at least in the millimeter range. For example, the dimension can be at least about 0.5 mm, such as at least about 1 mm, such as at least about 2 mm, such as at least about 4 mm, such as at least about 5 mm, such as at least about 6 mm, such as at least about 8 mm, such as at least about 10 mm, such as at least about 12 mm. Depending on the geometry, the dimension can refer to the diameter, radius, thickness, width, length, etc. A BMG can also be a metallic glass having at least one dimension in the centimeter range, such as at least about 1.0 cm, such as at least about 2.0 cm, such as at least about 5.0 cm, such as at least about 10.0 cm. In some embodiments, a BMG can have at least one dimension at least in the meter range. A BMG can take any of the shapes or forms described above, as related to a metallic glass. Accordingly, a BMG described herein in some embodiments can be different from a thin film made by a conventional deposition technique in one important aspect—the former can be of a much larger dimension than the latter.

Amorphous metals can be an alloy rather than a pure metal. The alloys may contain atoms of significantly different sizes, leading to low free volume (and therefore having viscosity up to orders of magnitude higher than other metals and alloys) in a molten state. The viscosity prevents the atoms from moving enough to form an ordered lattice. The material structure may result in low shrinkage during cooling and resistance to plastic deformation. The absence of grain boundaries, the weak spots of crystalline materials in some cases, may, for example, lead to better resistance to wear and corrosion. In one embodiment, amorphous metals, while technically glasses, may also be much tougher and less brittle than oxide glasses and ceramics.

Thermal conductivity of amorphous materials may be lower than that of their crystalline counterparts. To achieve formation of an amorphous structure even during slower cooling, the alloy may be made of three or more components, leading to complex crystal units with higher potential energy and lower probability of formation. The formation of amorphous alloy can depend on several factors: the composition of the components of the alloy; the atomic radius of the components (preferably with a significant difference of over 12% to achieve high packing density and low free volume); and the negative heat of mixing the combination of components, inhibiting crystal nucleation and prolonging the time the molten metal stays in a supercooled state. However, as the formation of an amorphous alloy is based on many different variables, it can be difficult to make a prior determination of whether an alloy composition would form an amorphous alloy.

Amorphous alloys, for example, of boron, silicon, phosphorus, and other glass formers with magnetic metals (iron, cobalt, nickel) may be magnetic, with low coercivity and high electrical resistance. The high resistance leads to low losses by eddy currents when subjected to alternating magnetic fields, a property useful, for example, as transformer magnetic cores.

Amorphous alloys may have a variety of potentially useful properties. In particular, they tend to be stronger than crystalline alloys of similar chemical composition, and they can sustain larger reversible (“elastic”) deformations than crystalline alloys. Amorphous metals derive their strength directly from their non-crystalline structure, which can have none of the defects (such as dislocations) that limit the strength of crystalline alloys. For example, one modern amorphous metal, known as Vitreloy™, has a tensile strength that is almost twice that of high-grade titanium. In some embodiments, metallic glasses at room temperature are not ductile and tend to fail suddenly when loaded in tension, which limits the material applicability in reliability-critical applications, as the impending failure is not evident. Therefore, to overcome this challenge, metal matrix composite materials having a metallic glass matrix containing dendritic particles or fibers of a ductile crystalline metal can be used. Alternatively, a BMG low in element(s) that tend to cause embitterment (e.g., Ni) can be used. For example, a Ni-free BMG can be used to improve the ductility of the BMG.

Another useful property of bulk amorphous alloys is that they can be true glasses; in other words, they can soften and flow upon heating. This can allow for easy processing, such as by injection molding, in much the same way as polymers. As a result, amorphous alloys can be used for making sports equipment, medical devices, electronic components and equipment, and thin films. Thin films of amorphous metals can be deposited as protective coatings via a high velocity oxygen fuel technique.

A material can have an amorphous phase, a crystalline phase, or both. The amorphous and crystalline phases can have the same chemical composition and differ only in the microstructure—i.e., one amorphous and the other crystalline. Microstructure in one embodiment refers to the structure of a material as revealed by a microscope at 25× magnification or higher. Alternatively, the two phases can have different chemical compositions and microstructures. For example, a composition can be partially amorphous, substantially amorphous, or completely amorphous.

As described above, the degree of amorphicity (and conversely the degree of crystallinity) can be measured by fraction of crystals present in the alloy. The degree can refer to volume fraction of weight fraction of the crystalline phase present in the alloy. A partially amorphous composition can refer to a composition of at least about 5 vol % of which is of an amorphous phase, such as at least about 10 vol %, such as at least about 20 vol %, such as at least about 40 vol %, such as at least about 60 vol %, such as at least about 80 vol %, such as at least about 90 vol %. The terms “substantially” and “about” have been defined elsewhere in this application. Accordingly, a composition that is at least substantially amorphous can refer to one of which at least about 90 vol % is amorphous, such as at least about 95 vol %, such as at least about 98 vol %, such as at least about 99 vol %, such as at least about 99.5 vol %, such as at least about 99.8 vol %, such as at least about 99.9 vol %. In one embodiment, a substantially amorphous composition can have some incidental, insignificant amount of crystalline phase present therein.

In one embodiment, an amorphous alloy composition can be homogeneous with respect to the amorphous phase. A substance that is uniform in composition is homogeneous. This is in contrast to a substance that is heterogeneous. The term “composition” refers to the chemical composition and/or microstructure in the substance. A substance is homogeneous when a volume of the substance is divided in half and both halves have substantially the same composition. For example, a particulate suspension is homogeneous when a volume of the particulate suspension is divided in half and both halves have substantially the same volume of particles. However, it might be possible to see the individual particles under a microscope. Another example of a homogeneous substance is air where different ingredients therein are equally suspended, though the particles, gases and liquids in air can be analyzed separately or separated from air.

A composition that is homogeneous with respect to an amorphous alloy can refer to one having an amorphous phase substantially uniformly distributed throughout its microstructure. In other words, the composition macroscopically comprises a substantially uniformly distributed amorphous alloy throughout the composition. In an alternative embodiment, the composition can be of a composite, having an amorphous phase having therein a non-amorphous phase. The non-amorphous phase can be a crystal or a plurality of crystals. The crystals can be in the form of particulates of any shape, such as spherical, ellipsoid, wire-like, rod-like, sheet-like, flake-like, or an irregular shape. In one embodiment, it can have a dendritic form. For example, an at least partially amorphous composite composition can have a crystalline phase in the shape of dendrites dispersed in an amorphous phase matrix; the dispersion can be uniform or non-uniform, and the amorphous phase and the crystalline phase can have the same or a different chemical composition. In one embodiment, they have substantially the same chemical composition. In another embodiment, the crystalline phase can be more ductile than the BMG phase.

The methods described herein can be applicable to any type of amorphous alloy. Similarly, the amorphous alloy described herein as a constituent of a composition or article can be of any type. The amorphous alloy can comprise the element Zr, Hf, Ti, Cu, Ni, Pt, Pd, Fe, Mg, Au, La, Ag, Al, Mo, Nb, Be, or combinations thereof. Namely, the alloy can include any combination of these elements in its chemical formula or chemical composition. The elements can be present at different weight or volume percentages. For example, an iron “based” alloy can refer to an alloy having a non-insignificant weight percentage of iron present therein, the weight percent can be, for example, at least about 20 wt %, such as at least about 40 wt %, such as at least about 50 wt %, such as at least about 60 wt %, such as at least about 80 wt %. Alternatively, in one embodiment, the above-described percentages can be volume percentages, instead of weight percentages. Accordingly, an amorphous alloy can be zirconium-based, titanium-based, platinum-based, palladium-based, gold-based, silver-based, copper-based, iron-based, nickel-based, aluminum-based, molybdenum-based, and the like. The alloy can also be free of any of the aforementioned elements to suit a particular purpose. For example, in some embodiments, the alloy, or the composition including the alloy, can be substantially free of nickel, aluminum, titanium, beryllium, or combinations thereof. In one embodiment, the alloy or the composite is completely free of nickel, aluminum, titanium, beryllium, or combinations thereof.

For example, the amorphous alloy can have the formula (Zr, Ti)ₐ(Ni, Cu, Fe)_{b}(Be, Al, Si, B)_{c}, wherein a, b, and c each represents a weight or atomic percentage. In one embodiment, a is in the range of from 30 to 75, b is in the range of from 5 to 60, and c is in the range of from 0 to 50 in atomic percentages. Alternatively, the amorphous alloy can have the formula (Zr, Ti)ₐ(Ni, Cu)_{b}(Be)_{c}, wherein a, b, and c each represents a weight or atomic percentage. In one embodiment, a is in the range of from 40 to 75, b is in the range of from 5 to 50, and c is in the range of from 5 to 50 in atomic percentages. The alloy can also have the formula (Zr, Ti)ₐ(Ni, Cu)_{b}(Be)_{c}, wherein a, b, and c each represents a weight or atomic percentage. In one embodiment, a is in the range of from 45 to 65, b is in the range of from 7.5 to 35, and c is in the range of from 10 to 37.5 in atomic percentages. Alternatively, the alloy can have the formula (Zr)ₐ(Nb, Ti)_{b}(Ni, Cu)_{c}(Al)_{d}, wherein a, b, c, and d each represents a weight or atomic percentage. In one embodiment, a is in the range of from 45 to 65, b is in the range of from 0 to 10, c is in the range of from 20 to 40 and d is in the range of from 7.5 to 15 in atomic percentages. One exemplary embodiment of the aforedescribed alloy system is a Zr—Ti—Ni—Cu—Be based amorphous alloy under the trade name Vitreloy™, such as Vitreloy-1 and Vitreloy-101, as fabricated by Liquidmetal Technologies, CA, USA. Some examples of amorphous alloys of the different systems are provided in Table 1 and Table 2.

TABLE 1
Exemplary amorphous alloy compositions

| Alloy | Atm % | Atm % | Atm % | Atm % | Atm % | Atm % | Atm % | Atm % |
|---|---|---|---|---|---|---|---|---|
| 1 | Fe | Mo | Ni | Cr | P | C | B | |
| | 68.00% | 5.00% | 5.00% | 2.00% | 12.50% | 5.00% | 2.50% | |
| 2 | Fe | Mo | Ni | Cr | P | C | B | Si |
| | 68.00% | 5.00% | 5.00% | 2.00% | 11.00% | 5.00% | 2.50% | 1.50% |
| 3 | Pd | Cu | Co | P | | | | |
| | 44.48% | 32.35% | 4.05% | 19.11% | | | | |
| 4 | Pd | Ag | Si | P | | | | |
| | 77.50% | 6.00% | 9.00% | 7.50% | | | | |
| 5 | Pd | Ag | Si | P | Ge | | | |
| | 79.00% | 3.50% | 9.50% | 6.00% | 2.00% | | | |
| 5 | Pt | Cu | Ag | P | B | Si | | |
| | 74.70% | 1.50% | 0.30% | 18.0% | 4.00% | 1.50% | | |

TABLE 2
Additional Exemplary amorphous alloy compositions (atomic %)

| Alloy | Atm % | Atm % | Atm % | Atm % | Atm % | Atm % |
|---|---|---|---|---|---|---|
| 1 | Zr | Ti | Cu | Ni | Be | |
| | 41.20% | 13.80% | 12.50% | 10.00% | 22.50% | |
| 2 | Zr | Ti | Cu | Ni | Be | |
| | 44.00% | 11.00% | 10.00% | 10.00% | 25.00% | |
| 3 | Zr | Ti | Cu | Ni | Nb | Be |
| | 56.25% | 11.25% | 6.88% | 5.63% | 7.50% | 12.50% |
| 4 | Zr | Ti | Cu | Ni | Al | Be |
| | 64.75% | 5.60% | 14.90% | 11.15% | 2.60% | 1.00% |
| 5 | Zr | Ti | Cu | Ni | Al | |
| | 52.50% | 5.00% | 17.90% | 14.60% | 10.00% | |
| 6 | Zr | Nb | Cu | Ni | Al | |
| | 57.00% | 5.00% | 15.40% | 12.60% | 10.00% | |
| 7 | Zr | Cu | Ni | Al | | |
| | 50.75% | 36.23% | 4.03% | 9.00% | | |
| 8 | Zr | Ti | Cu | Ni | Be | |
| | 46.75% | 8.25% | 7.50% | 10.00% | 27.50% | |
| 9 | Zr | Ti | Ni | Be | | |
| | 21.67% | 43.33% | 7.50% | 27.50% | | |
| 10 | Zr | Ti | Cu | Be | | |
| | 35.00% | 30.00% | 7.50% | 27.50% | | |
| 11 | Zr | Ti | Co | Be | | |
| | 35.00% | 30.00% | 6.00% | 29.00% | | |
| 12 | Zr | Ti | Fe | Be | | |
| | 35.00% | 30.00% | 2.00% | 33.00% | | |
| 13 | Au | Ag | Pd | Cu | Si | |
| | 49.00% | 5.50% | 2.30% | 26.90% | 16.30% | |
| 14 | Au | Ag | Pd | Cu | Si | |
| | 50.90% | 3.00% | 2.30% | 27.80% | 16.00% | |
| 15 | Pt | Cu | Ni | P | | |
| | 57.50% | 14.70% | 5.30% | 22.50% | | |
| 16 | Zr | Ti | Nb | Cu | Be | |
| | 36.60% | 31.40% | 7.00% | 5.90% | 19.10% | |
| 17 | Zr | Ti | Nb | Cu | Be | |
| | 38.30% | 32.90% | 7.30% | 6.20% | 15.30% | |
| 18 | Zr | Ti | Nb | Cu | Be | |
| | 39.60% | 33.90% | 7.60% | 6.40% | 12.50% | |
| 19 | Cu | Ti | Zr | Ni | | |
| | 47.00% | 34.00% | 11.00% | 8.00% | | |
| 20 | Zr | Co | Al | | | |
| | 55.00% | 25.00% | 20.00% | | | |

Other exemplary ferrous metal-based alloys include compositions such as those disclosed in U.S. Patent Application Publication Nos. 2007/0079907 and 2008/0118387. These compositions include the Fe(Mn, Co, Ni, Cu) (C, Si, B, P, Al) system, wherein the Fe content is from 60 to 75 atomic percentage, the total of (Mn, Co, Ni, Cu) is in the range of from 5 to 25 atomic percentage, and the total of (C, Si, B, P, Al) is in the range of from 8 to 20 atomic percentage, as well as the exemplary composition Fe48Cr15Mo14Y2C15B6. They also include the alloy systems described by Fe—Cr—Mo—(Y,Ln)—C—B, Co—Cr—Mo-Ln-C—B, Fe—Mn—Cr—Mo—(Y,Ln)—C—B, (Fe, Cr, Co)—(Mo,Mn)—(C,B)—Y, Fe—(Co,Ni)—(Zr,Nb,Ta)—(Mo,W)—B, Fe—(Al,Ga)—(P,C,B,Si,Ge), Fe—(Co,Cr,Mo,Ga,Sb)—P—B—C, (Fe, Co)—B—Si—Nb alloys, and Fe—(Cr—Mo)—(C,B)—Tm, where Ln denotes a lanthanide element and Tm denotes a transition metal element. Furthermore, the amorphous alloy can also be one of the exemplary compositions Fe80P12.5C5B2.5, Fe80P11C5B2.5Si1.5, Fe74.5Mo5.5P12.5C5B2.5, Fe74.5Mo5.5P11C5B2.5Si1.5, Fe70Mo5Ni5P12.5C5B2.5, Fe70Mo5Ni5P11C5B2.5Si1.5, Fe68Mo5Ni5Cr2P12.5C5B2.5, and Fe68Mo5Ni5Cr2P11C5B2.5Si1.5, described in U.S. Patent Application Publication No. 2010/0300148.

The amorphous alloys can also be ferrous alloys, such as (Fe, Ni, Co) based alloys. Examples of such compositions are disclosed in U.S. Pat. Nos. 6,325,868; 5,288,344; 5,368,659; 5,618,359; and 5,735,975, Inoue et al., Appl. Phys. Lett., Volume 71, p 464 (1997), Shen et al., Mater. Trans., JIM, Volume 42, p 2136 (2001), and Japanese Patent Application No. 200126277 (Pub. No. 2001303218 A). One exemplary composition is Fe₇₂Al₅Ga₂P₁₁C₆B₄. Another example is Fe₇₂Al₇Zr₁₀Mo₅W₂B₁₅. Another iron-based alloy system that can be used in the coating herein is disclosed in U.S. Patent Application Publication No. 2010/0084052, wherein the amorphous metal contains, for example, manganese (1 to 3 atomic %), yttrium (0.1 to 10 atomic %), and silicon (0.3 to 3.1 atomic %) in the range of composition given in parentheses; and that contains the following elements in the specified range of composition given in parentheses: chromium (15 to 20 atomic %), molybdenum (2 to 15 atomic %), tungsten (1 to 3 atomic %), boron (5 to 16 atomic %), carbon (3 to 16 atomic %), and the balance iron.

The amorphous alloy can also be one of the Pt- or Pd-based alloys described by U.S. Patent Application Publication Nos. 2008/0135136, 2009/0162629, and 2010/0230012. Exemplary compositions include Pd44.48Cu32.35Co4.05P19.11, Pd77.5Ag6Si9P7.5, and Pt74.7Cu1.5Ag0.3P18B4Si1.5.

The aforedescribed amorphous alloy systems can further include additional elements, such as additional transition metal elements, including Nb, Cr, V, and Co. The additional elements can be present at less than or equal to about 30 wt %, such as less than or equal to about 20 wt %, such as less than or equal to about 10 wt %, such as less than or equal to about 5 wt %. In one embodiment, the additional, optional element is at least one of cobalt, manganese, zirconium, tantalum, niobium, tungsten, yttrium, titanium, vanadium and hafnium to form carbides and further improve wear and corrosion resistance. Further optional elements may include phosphorous, germanium and arsenic, totaling up to about 2%, and preferably less than 1%, to reduce melting point. Otherwise incidental impurities should be less than about 2% and preferably 0.5%.

In some embodiments, a composition having an amorphous alloy can include a small amount of impurities. The impurity elements can be intentionally added to modify the properties of the composition, such as improving the mechanical properties (e.g., hardness, strength, fracture mechanism, etc.) and/or improving the corrosion resistance. Alternatively, the impurities can be present as inevitable, incidental impurities, such as those obtained as a byproduct of processing and manufacturing. The impurities can be less than or equal to about 10 wt %, such as about 5 wt %, such as about 2 wt %, such as about 1 wt %, such as about 0.5 wt %, such as about 0.1 wt %. In some embodiments, these percentages can be volume percentages instead of weight percentages. In one embodiment, the alloy sample/composition consists essentially of the amorphous alloy (with only a small incidental amount of impurities). In another embodiment, the composition includes the amorphous alloy (with no observable trace of impurities).

In one embodiment, the final parts exceeded the critical casting thickness of the bulk solidifying amorphous alloys.

In embodiments herein, the existence of a supercooled liquid region in which the bulk-solidifying amorphous alloy can exist as a high viscous liquid allows for superplastic forming. Large plastic deformations can be obtained. The ability to undergo large plastic deformation in the supercooled liquid region is used for the forming and/or cutting process. As oppose to solids, the liquid bulk solidifying alloy deforms locally which drastically lowers the required energy for cutting and forming. The ease of cutting and forming depends on the temperature of the alloy, the mold, and the cutting tool. As higher is the temperature, the lower is the viscosity, and consequently easier is the cutting and forming.

Embodiments herein can utilize a thermoplastic-forming process with amorphous alloys carried out between Tg and Tx, for example. Herein, Tx and Tg are determined from standard DSC measurements at typical heating rates (e.g. 20° C./min) as the onset of crystallization temperature and the onset of glass transition temperature.

The amorphous alloy components can have the critical casting thickness and the final part can have thickness that is thicker than the critical casting thickness. Moreover, the time and temperature of the heating and shaping operation is selected such that the elastic strain limit of the amorphous alloy could be substantially preserved to be not less than 1.0%, and preferably not being less than 1.5%. In the context of the embodiments herein, temperatures around glass transition means the forming temperatures can be below glass transition, at or around glass transition, and above glass transition temperature, but preferably at temperatures below the crystallization temperature T_{X}. The cooling step is carried out at rates similar to the heating rates at the heating step, and preferably at rates greater than the heating rates at the heating step. The cooling step is also achieved preferably while the forming and shaping loads are still maintained.

### Electronic Devices

The embodiments herein can be valuable in the fabrication of electronic devices using a BMG. An electronic device herein can refer to any electronic device known in the art. For example, it can be a telephone, such as a cell phone, and a land-line phone, or any communication device, such as a smart phone, including, for example an iPhone™, and an electronic email sending/receiving device. It can be a part of a display, such as a digital display, a TV monitor, an electronic-book reader, a portable web-browser (e.g., iPad™), and a computer monitor. It can also be an entertainment device, including a portable DVD player, conventional DVD player, Blue-Ray disk player, video game console, music player, such as a portable music player (e.g., iPod™), etc. It can also be a part of a device that provides control, such as controlling the streaming of images, videos, sounds (e.g., Apple TV™), or it can be a remote control for an electronic device. It can be a part of a computer or its accessories, such as the hard drive tower housing or casing, laptop housing, laptop keyboard, laptop track pad, desktop keyboard, mouse, and speaker. The article can also be applied to a device such as a watch or a clock.

In some embodiments, a composition having an amorphous alloy can include a small amount of impurities. The impurity elements can be intentionally added to modify the properties of the composition, such as improving the mechanical properties (e.g., hardness, strength, fracture mechanism, etc.) and/or improving the corrosion resistance. Alternatively, the impurities can be present as inevitable, incidental impurities, such as those obtained as a byproduct of processing and manufacturing. The impurities can be less than or equal to about 10 wt %, such as about 5 wt %, such as about 2 wt %, such as about 1 wt %, such as about 0.5 wt %, such as about 0.1 wt %. In some embodiments, these percentages can be volume percentages instead of weight percentages. In one embodiment, the alloy sample/composition consists essentially of the amorphous alloy (with only a small incidental amount of impurities). In another embodiment, the composition consists of the amorphous alloy (with no observable trace of impurities).

### Ultrasonic Measurement

In one embodiment, ultrasonic scanning and/or measurement can be used to characterize a sample. Ultrasonic measurement techniques are known. They can be utilized for a variety of applications, from finding defects and flaws in metallic parts to imaging human internal organs. In addition to being relatively simple to use, ultrasonic measurements can have the added benefit of being nondestructive. There are a variety of methods, be it contact or non-contact, of conducting ultrasonic measurements or observations on a sample.

In one embodiment, the ultrasonic measurement can be carried out by Resonant Ultrasound Spectroscopy (RUS). RUS uses normal modes of elastic bodies to infer material properties, such as elastic moduli and Q factor (or “Q” for short), which is described further below. In principle, the complete elastic tensor can be inferred from a single measurement. For centimeter-sized samples RUS can fill an experimental gap between low-frequency stress-strain methods (quasi-static up to a few kHz) and ultrasonic time-delay methods (hundreds of kHz to GHz). Synchronous detection methods are used to measure the resonance spectra of homogeneous rock samples. These spectra are then fit interactively with a model to extract the normal-mode frequencies and Q factors.

In general, RUS measures the free-body resonances of a solid material and uses them to compute all of the material's elastic constants. The frequency range used during scanning can be of any value, depending on the application. In some embodiments, a measurement scans a frequency range from a few kHz up to several GHz and generally includes the first twenty to thirty resonances. A set of elastic constants can then be determined, which is consistent with the measured resonance spectrum. Advantages of RUS can include that all elastic constants are determined by a single measurement and only a small sample (in the millimeter range) needs to be used.

The ultrasonic measurement or observation described herein can be carried out by any ultrasonic measurement instrumentation readily appreciated in the art. An ultrasonic measurement instrumentation can comprise a transducer, an oscilloscope, and an electrical pulser/receiver (PR). The PR can generate electronic wavepackets, which the piezoelectric transducer converts into mechanical oscillations that are sent into a sample. In one embodiment, two types of generally available transducers can be employed: those that generate shear waves and those that generate longitudinal waves. Longitudinal waves can produce oscillations in the direction of propagation of the wave while shear waves produce oscillations perpendicular to the direction of the wave propagation. In one embodiment, both types of transducers can be used in an attempt to obtain a comprehensive profile of the elastic properties of the materials. The ultrasonic measurement instrumentation described herein can be controlled by a computer software.

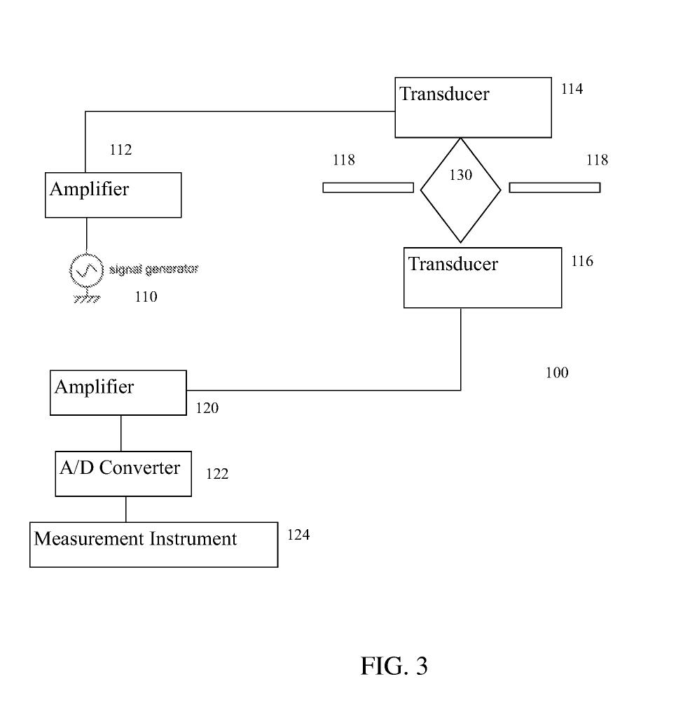

FIG. 3 shows a schematic of the setup used for the ultrasonic measurement described in one embodiment. An apparatus 100 is used to apply ultrasonic excitations. For example, the apparatus 100 can be used for RUS to examine a BMG sample 130. The BMG sample 130 may be a part of a larger piece of BMG. The larger piece can be, for example, a structural part of a device. The device can be, for example, an electronic device, which is described in greater detail below. In one embodiment, the part can be the housing of an electronic device. For example, the BMG sample 130 may have been formed as a gate protruding from the larger piece of BMG and was cut from the larger piece so that quality control tests can be performed thereon. The BMG sample 130 may have any suitable size and shape, such as a cylinder, a cube, a sphere, or a parallelepiped. The BMG sample 130 may also be polished to remove dust or other materials that can dampen the BMG 130's response to the excitations. For example, the BMG sample 130 may be polished to have sharp edges. Further, the BMG sample 130 may be cut to desired dimensions with a diamond saw and polished with a lapping machine.

The BMG sample 130 can be at least partially amorphous, such as at least substantially amorphous, such as fully amorphous. Because of the sensitivity of ultrasonic measurements to the different phases of a material, the measurement can be used to identify the different phases. For example, because a crystalline phase and an amorphous phase of a material (of the same chemical composition) have different elastic properties, ultrasonic measurements can be used to identify the presence of a crystal (or crystals) in an amorphous material. The crystal(s) can be present in any location in the amorphous alloy material. In some embodiments, the crystals can be present as a result of manufacturing flaws. Thus, identifying the presence of the crystal can help identify the flaw in the process of making an alloy (or an alloy part), thereby providing quality control. The process of making an amorphous alloy, such as a BMG, is known. One embodiment thereof can include quenching a molten alloy charge to a temperature below a glass transition temperature of the alloy sufficiently fast to avoid crystallization.

Ultrasonic excitations may be applied by transducer 114, transducer 116, or both as shown in FIG. 3. In one embodiment, transducer 114 applies ultrasonic excitations while transducer 116 measures response(s) of the sample 130 to the excitations. The transducers 114 and/or 116 may be piezoelectric transducers, such as lithium niobate or zirconate titanate transducers, or another type of transducer capable of applying ultrasonic excitations and/or detecting the responses thereto. In one embodiment, the transducers apply the excitations through direct contact to a BMG sample 130 that is shaped as a parallelepiped. The transducers 114 and/or 116 may contact the parallelepiped at any suitable locations thereof, such as at its corners. Direct contact is not needed in some embodiments. In another embodiment, the transducers 114 and/or 116 may indirectly contact the BMG sample 130. For example, the sample material 130 may be mounted in the middle of a plastic sheet or a buffer rod that in turn directly contacts the transducers 114 and/or 116. The transducers 114 and/or 116 may be able to generate and detect excitations at a plurality of frequencies, such as a range from 10 kHz to 35 MHz. Alternatively, the frequency can be higher or lower than the aforementioned ranges.

In another embodiment, the transducers 114 and/or 116 may be configured to transmit ultrasonic pulses and to measure how the pulses reflect off of or pass through the BMG sample 130. For example, transducer 114 may be configured to transmit a pulse while transducer 116 or another sensor may be configured to measure the speed of sound of the pulse after it passes through BMG sample 130.

To avoid cross talk between the transducers, a shield 118 may be placed between transducers 114 and 116. For example, a polyimide sheet 118 may be placed in the middle of the transducers to shield them from each other. A hole may be cut in the middle of the sheet 118 to allow both transducers to directly contact the BMG sample 130. In another embodiment, the shield 118 may be a sheet of copper that is grounded.

The excitation signal applied by the transducer 114 may be generated by a signal generator 110. The signal generator may be able to generate signals at a single frequency mode or in a swept frequency continuous wave (CW) mode. The signals may be enhanced by an amplifier 112 before being passed to the transducer 114.

The response of the BMG sample 130 to the ultrasonic excitations from transducer 114 may be measured by transducer 116, or vice versa. The measurement may correlate to the surface displacement amplitude of the BMG sample 130 in response to ultrasonic excitations. The measured response may be amplified by amplifier 120, converted to a digital format at an analog/digital converter 122, and processed by a measuring instrument 124. In one embodiment, the instrument may be a computer that is connected to the amplifier via a coaxial cable.

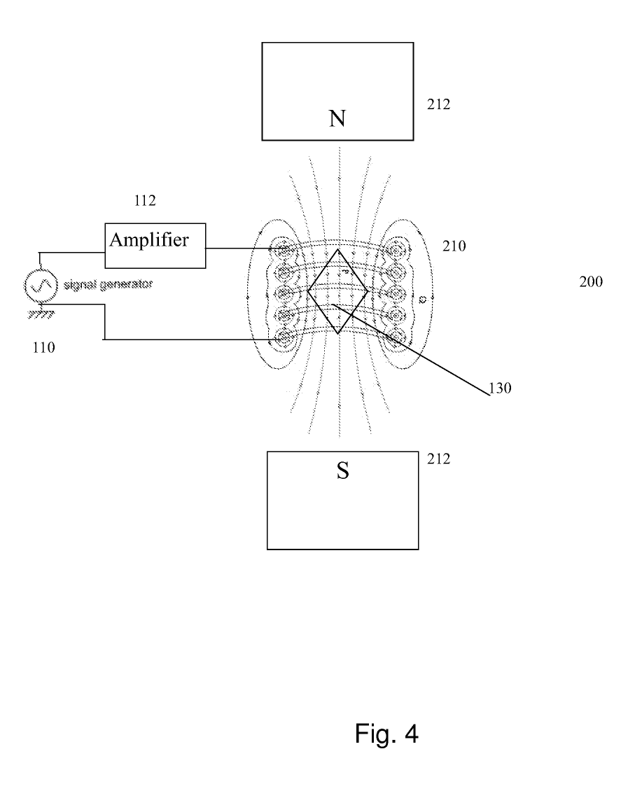

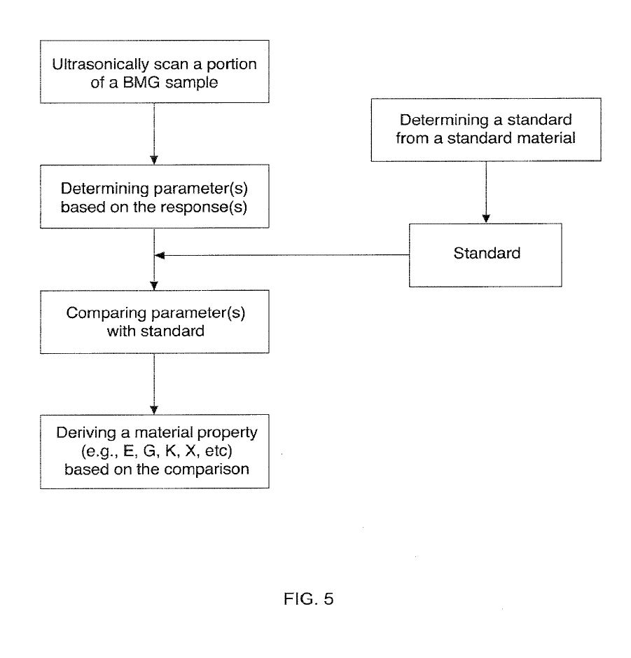

FIG. 4 shows an embodiment of a non-contact ultrasonic testing apparatus 200 that applies ultrasonic excitations without directly touching the BMG sample 130. The signals generated by the signal generator 110 of the embodiment may be a burst of AC current that is amplified and fed to a solenoid 210. A magnet 212 can be made to create a magnetic field inside the solenoid 210. The AC current may induce AC currents in the BMG sample 130, which can combine with the magnetic field to generate Lorentz forces that can create mechanical vibrations. Mechanical resonance in the material 130 may be created based on the frequency of the AC current. The solenoid 210 may be configured to detect and measure the vibrations in the BMG sample 130 in between the successive excitation bursts.

The responses of the BMG sample 130 to the ultrasonic excitations at one or more frequencies may be used to determine the resonant frequencies and Q factor(s) of BMGs. “Q factor” at a resonance frequency in one embodiment can refer to the resonance frequency divided by the bandwidth of the response at that frequency. The bandwidth may refer to the frequency range in which the amplitude response is more than half (e.g., within 3 dBs) of the peak amplitude response, and can be measured and determined by any known method. Because ultrasonic measurement can be sensitive to the presence of inhomogeneity—e.g., in one embodiment the presence of a crystal in an amorphous alloy; —two BMGs of different crystallinity can have different sets of responses, indicating different resonance frequencies, different Q factors, or both. Note that crystallinity can be of any value, and thus can be determined. A crystallinity of zero, for example, can refer to a fully amorphous alloy.

The response obtained from an ultrasonic measurement can be used to determine material parameter of the material. One of these parameters is the elastic constants of the material. For elastic waves in an isotropic medium, the following equations hold:

$${C}_{t} = \sqrt{\frac{μ}{ρ}} = \sqrt{\frac{G}{ρ}}$$

$${C}_{l} = \sqrt{\frac{λ + 2 μ}{ρ}} = \sqrt{\frac{3 K + 4 G}{3 ρ}} .$$

In these equations, Cₜ is the transverse, or shear, sound velocity; the shear wave propagates through a sample with the direction of material motion perpendicular to the direction of wave propagation. Cₗ is the longitudinal sound velocity, in which the material motion is parallel to the direction of the wave propagation (this is sometimes called a compressional or pressure-wave). Some parameters, p and A, are commonly used in elasticity theory, p is the density of the material, G is the shear modulus, and K is the bulk modulus. By measuring Cₜ, Cₗ, and p, the equations above can be solved for G and K or X and p. In other words, by determining the material parameter(s), such as the elastic constants, the measurement methods described herein can help derive material properties, such as the different aforementioned moduli. A material property can also refer to, for example, elastic moduli, Q factors, crystallinity (including presence of crystals), chemical properties, mechanical properties, or combinations thereof.

Alternatively,

$$G = \frac{δτ}{δ γ} ,$$

where is the shear stress and is the shear strain. The thermodynamic definition of bulk modulus can be as follows:

$$K = - V ( \frac{δ P}{δ V} ) .$$

In one embodiment, as first determined by MD simulations and later by experiments, the bulk modulus of a glassy metal can be about 0.95 K_{crystalline}, while the shear modulus of a glassy meal can be about 0.7G_{crystalline}. The Poisson ratio is a combination of both the shear and bulk moduli and is defined as follows:

$$v = - \frac{{ε}_{lateral}}{{ε}_{longitudinal}} = \frac{λ}{2 ( λ + μ )} = \frac{1}{2} [ \frac{3 - 2 \frac{G}{K}}{3 + \frac{G}{K}} ] .$$

In theory, the Poisson ratio can range from a negative value to 0.5—most rubbers have a Poisson ratio of 0.45 while cork has a Poisson ratio close to 0. In the limit where G approaches 0, the Poisson ratio approaches 0.5, corresponding to a material with conservation of volume upon deformation. In glassy alloys, the Poisson ratio can be correlated with the liquid fragility as well as the fracture toughness and ductility of glassy alloys. In one embodiment, material properties such as Young's modulus may also be calculated from these measured values.

Various types of ultrasonic measurements can be used. For example, the ultrasonic measurement described herein can utilize pulse-echo technique and/or through transmission technique. In pulse-echo measurements the acoustic signal is sent and received with a single transducer. Successive reflections off of the “back-wall” of the sample are overlapped, and thus the time delay for the signal to travel two lengths of the sample is calculated.

In through-transmission measurements the acoustic signal is generated in one transducer and received by a second transducer. The signal passes once through the length of the sample, or a portion thereof. Prior to sample measurement, the intrinsic time delay of the signal to pass from the first to the second transducer can be measured and then subtracted from the time measured with the sample. Through-transmission measurements are useful for materials that have strong acoustic-attenuation. Ultrasonic waves generally travel with low attenuation in rough metallic materials, due to the high density and uniformity of the material. By contrast, ultrasonic waves do not propagate well through porous or mechanically “soft” materials.

Depending on the application, the ultrasonic measurement can be carried out at any desirable temperature. For example, in one embodiment, the measurement can be carried out at room temperature. In another embodiment, the measurement could be carried out at temperatures up to and in the region of the glass transition and crystallization temperature of the alloy (which can be in the 400-500C) which could allow for real time monitoring of a glass during a thermoforming operation. That is, one can determine when the glass undergoes glass transition and when it has crystallized using magnetostrictive ultrasonic transducers having a wave guide element (so the transducer does not come into contact with the sample) and a thin cross section wave guide (which could also minimize conductive heat transfer by allowing high heat dissipation to environment high area as disclosed in “High-temperature (>500° C.) wall thickness monitoring using dry-coupled ultrasonic waveguide transducers” by Frederic B Cegla, Peter Cawley, Jonathan Allin, Jacob Davies (available at http://www.mendeley.com/research/hightemperature-500c-wall-thickness-monitoring-using-drycoupled-ultrasonic-waveguide-transducers/). The system of Cegla et al. uses a waveguide to isolate the vulnerable transducer and piezoelectric elements from the high-temperature measurement zone. Use of thin and long waveguides of rectangular cross section allows large temperature gradients to be sustained over short distances without the need for additional cooling equipment. The main problems that had to be addressed were the transmission and reception of ultrasonic waves into and from the testpiece that the waveguides are coupled to, and optimization of the wave propagation along the waveguide itself. It was found that anti-plane shear loading performs best at transmitting and receiving from the surface of a component that is to be inspected. Therefore, a nondispersive guided wave mode in large-aspect-ratio rectangular strips was employed to transmit the anti-plane shear loading from the transducer to the measurement zone.

Additional preparation of the sample can be applied. For example, it is desirable to have a sample of the proper size and shape with highly polished surfaces and to have a transducer of the proper frequency. The method of coupling the transducer and the sample can also be important. For example, the couplant for shear waves may need to be viscous enough to support the shear wave, while at the same time fluid enough to wet and form good contact between the face of the transducer and the sample. It can be important to predetermine the sample density and thickness in order to ensure the accuracy of the results.

Ultrasonic Measurement v. Crystallinity

One embodiment provided herein utilizes the sensitivity of the ultrasonic measurement technique to the presence of crystals as a technique to detect the presence of crystals. FIG. 5 provides an illustrative flowchart of the crystallinity determination process in one embodiment. In an alternative embodiment, the ultrasonic measurement can further be used to determine the degree of crystallinity—i.e., the amount of the presence of the crystals in the sample. For example, a certain degree of crystallinity can be corresponded/correlated with the responses/results obtained from the ultrasonic measurement. The determination can be carried out by first establishing a set of standards with predetermined correlation between crystallinity and ultrasonic measurement values and then comparing the measurement results obtained from an unknown sample with the predetermined standards. Other properties than crystallinity can also be determined. The elastic moduli of a composite can be estimated if one knows the elastic moduli of each component, the relative volume fractions of each component and the manner in which the elements are distributed (e.g. regular plies, particles in a matrix, fiber). By comparing the measured elastic constants of reference standards of known crystallinity (as determined by other inspection procedures e.g. DSC, Optical Microscopy) to the measured elastic constants of the sample having an unknown degree of crystallinity, one can determine the degree of crystallinity of the sample.

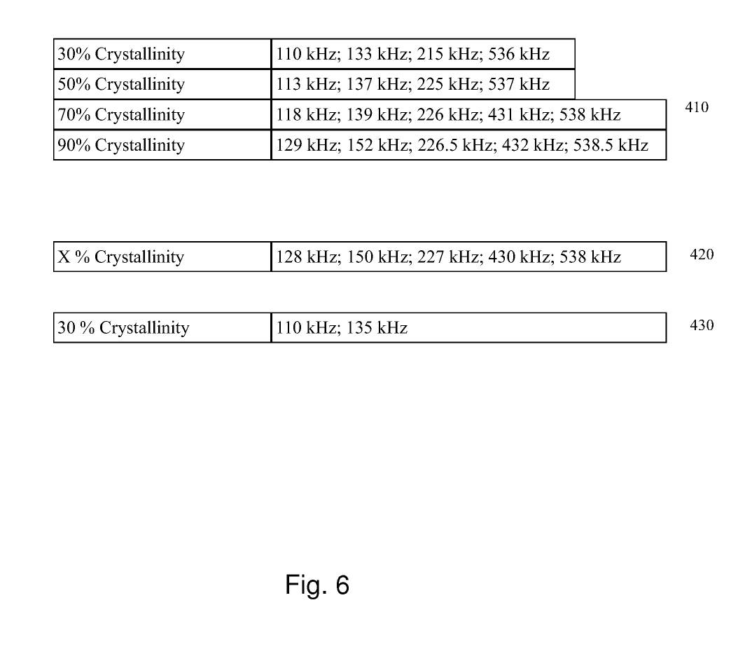

The measured resonance frequency responses can also be used to derive additional parameters or properties, such as the Q factors related to the material. The measurement responses (and additional parameters) can be stored in a database and/or used to establish a standard for a specific type of alloy (e.g., crystallinity). FIG. 6 shows an illustrative database 410 showing entries corresponding with the different crystallinity in BMG samples. The values are only for illustration purposes and are not in any way limited thereto.

The resonance frequencies can be of any value, depending on the alloy system. For example, the resonance frequencies can range from 100 kHz to 500 kHz, but may generally range from several hertz to several megahertz or gigahertz. Further, a BMG may have a few resonance frequencies, tens of resonance frequencies, or hundreds of resonance frequencies in the frequency range. The database 410 may also be configured to store the amplitude response values at one or more frequencies in the frequency range (e.g., in the 100-600 kHz range), the Q factor at each of the resonance frequencies, or other response values.

The ultrasonic measurement can be applied to the BMG sample in any suitable way. For example, the scanning can be applied to a portion of the sample, from which the responses (thus the material parameters) can be determined. The portion can be a single point, or can be a section of the sample. For example, it can be a portion of a surface, such as substantially an entire surface.

In one embodiment, at least one sample of predetermined material properties are ultrasonically scanned, and the responses to the ultrasonic excitations are correlated with at least one of the properties. One property can, for example, be crystallinity. The correlation can be the same as a standard to help determine the same material property of an unknown test sample by comparison. For example, if an unknown test sample has a certain response that matches the value(s) of a standard, then the unknown test sample may be deemed to have the same material property/parameter as the standard material.

In one embodiment, the sets of measured resonance frequency responses from the database 410 may be used as standards that can be used to determine the crystallinity of an unknown BMG sample. Alternatively, the standards can be used to detect the presence of crystals in an unknown BMG sample. For example, a recently manufactured BMG may be tested for its degree of crystallinity. In one embodiment, the presence of crystals can be undesirable. Ultrasonic excitations, such as through a RUS technique, may be applied to the BMG. The amplitude responses may also be measured to determine a set of resonance frequencies and/or Q factors for the BMG. FIG. 6 shows a set 420 of measured resonance frequencies for a BMG with an unknown degree of crystallinity. The measured response may be compared against the entries in the database 410 that store sets of measured resonance frequencies corresponding to known percentages of crystallinity. Any of the processes mentioned herein can be automated. For example, an algorithm may be used to find the best match of the set of responses of the recently manufactured BMG to the sets of responses in the database. For example, a least-squares procedure may be used to find a set of resonance frequencies in the database that produces a best fit on a least-squares basis. Alternatively, a computer executable software program can contain an algorithm that can execute any of the aforedescribed methods. The software can be stored in a computer readable medium. The medium can be a tangible, physical medium, such as a diskette, CD, DVD, hard drive, etc.

Detection of the presence of crystals, and by extension the amount of the crystals present, via ultrasonic measurements, may rely on different resonance properties between a material in an amorphous phase and the material in a crystalline phase. Resonance properties may first be measured for a BMG in which the value of a crystalline property is known. For example, a BMG may have a known degree of crystallinity. In one embodiment, to measure the resonance properties, ultrasonic excitations may be applied to a BMG sample or a portion thereof. The ultrasonic excitations may be applied in accordance with a resonant ultrasonic spectroscopy (RUS) technique. The excitations may be applied at a fixed frequency or swept over a range of frequencies. The amplitude response of the BMGs in the range of frequencies may be measured to determine a set of one or more resonance frequencies of the BMG, the Q factor at of the material at each of the one or more resonant frequencies, or some other resonance property.

The excitations may be applied at an ultrasonic frequency generated by piezoelectric transducers. The excitations can be applied to a plurality of BMGs that have different known values of a crystalline property. The resonance properties, such as the set of resonant frequency values or Q factor values, can be associated in a database with the particular known value of the crystalline property. For example, a set of derived resonance frequencies and Q factors for a BMG may be associated with its known degree of crystallinity in a database.

The database can be used to determine samples of different degrees of crystallinity (or other properties) at the same time. For example, excitations may be applied to a sample of a recently manufactured BMG whose degree of crystallinity is not known. The excitations may be applied at a single frequency or swept over a range of frequencies. For excitations swept over a range of frequencies, the responses at the plurality of frequencies may be measured to determine a set of resonant frequencies of the sample of the recently manufactured BMG and the Q factor at each of the resonant frequencies. A comparison algorithm, such as one in an apparatus, may then compare the set of resonant frequencies of the sample with sets of resonant frequencies stored in the database. The comparison algorithm may identify the set of resonant frequencies in the database that most closely matches the set of resonant frequencies of the sample. The degree of crystallinity in the database corresponding to the matching set may be identified as the degree of crystallinity of the sample.

If multiple sets of resonant frequencies in the database closely match the set of resonant frequencies of the sample, the comparison algorithm may also compare the Q factors at those frequencies. The algorithm may identify the set of resonance frequencies in the database with the most closely matching Q values. The corresponding crystallinity in the database may then be identified as the best estimate of the crystallinity of the sample.

### Quality Control

The presently described techniques can be applied to a plurality of test samples. Alternatively, they can be applied to one sample at different locations thereof. For example, the scanning can be applied to different locations on a surface of a sample in order to examine the uniformity of the material property. In one embodiment, based on the comparison and determination, the presently described methods can help evaluate the quality of the BMG manufacturing process. The standard can be predetermined or can be determined in the same setting as the test sample evaluation. Any of the processes described herein can be repeated. For example, scanning, comparing, and/or evaluating can be repeated at multiple locations on a sample or on multiple samples.

The techniques described herein can be further extended to detecting defects in a BMG. In one embodiment, a database may store the amplitude response at one or more frequencies of a BMG with a known crystallinity. The one or more frequencies may include a known resonance frequency of the BMG. To test a BMG sample having the same crystallinity, the BMG sample may be subjected to ultrasonic excitations at one of the one or more frequencies. The amplitude response at that frequency may be normalized for both the sample and the database value. The normalizing may be based on the strength of the ultrasonic excitations and the mass of the BMG sample compared to the mass of the BMG from which the database value was measured. A comparison of the normalized amplitude responses for a particular frequency may indicate whether the sample material is defective.

A defect may have, for example, dampened the BMG sample's amplitude response at that frequency. In another embodiment, a database may store a set of resonance frequencies of a BMG of a known crystallinity. To test a BMG sample of the same crystallinity, ultrasonic excitations may be applied to the BMG sample over a range of frequencies that cover the resonance frequencies in the database. The response of the BMG sample may be used to determine a set of resonance frequencies. This experimental set of resonance frequencies may be compared against the set of resonance frequencies corresponding to the known crystallinity in the database. The comparison may indicate whether the BMG sample is defective. For example, a defect in the sample material may have dampened the BMG's response at higher frequencies, causing the sample to have missing resonance frequencies at the higher frequencies.

The identification of the flaw can also be integrated to evaluate the quality of the fabrication process, and the feedback therefrom can be used modify and/or improve the process. In one embodiment, because the crystal(s) can also be present as a defect, the ultrasonic methods described herein can be used to identify defects. For example, in one embodiment, if via the presently described methods crystals are found in a supposed BMG sample, the sample can be deemed rejected before it is made into a structural part of a device. In addition to rejecting the sample in the manufacturing process, the manufacturing process can be modified and improved based on the results of the presently described inspection methods.

The presently described methods can be stored in a computer-readable medium and executed by the same, as aforementioned. The methods can also be executed by an apparatus. In one embodiment, the apparatus is configured to carry out the method comprising: scanning ultrasonically at least a portion of a sample comprising a bulk amorphous alloy to determine a parameter of the sample in the portion; and comparing the parameter to a predetermined standard to derive a property related to the sample. The apparatus can be any of the machinery or equipment that can be used to carry out the processes described above. In one embodiment, the apparatus can become an integral part of a quality control feedback system that can provide feedback to the BMG part fabrication process (or plant) to allow the process to be modified or improved.

The inspection need not be carried out in the fabrication machinery, and instead can be carried out in several different locations. For example, ultrasonic excitations can be applied to a sample and the results obtained can be taken off-site (or on-site but away from the machinery) for comparison. In other words, the apparatus that performs the inspection and/or analysis need not be an integral part of the manufacturing system/setup. In one embodiment, a quality control method can be carried out by the following process: obtaining at least one standard parameter from at least one standard alloy sample by scanning ultrasonically the at least one standard alloy sample; obtaining a test parameter from a test alloy sample comprising a bulk amorphous alloy by scanning ultrasonically the test alloy sample; and evaluating the test alloy sample by comparing the standard parameter with the test parameter. The different parts of this process can be as described above. The results can be further independently verified. For example, another sample (or the same sample) can be inspected using another method, including a destructive technique, for comparison and/or verification.

If the sets of resonance frequencies among the database entries are too close to be differentiated and to find a best match to the resonance frequencies corresponding to the unknown crystallinity, Q factors may also be stored and compared. A BMG with a lower degree of crystallinity may have a higher Q value because the amorphous portion of the material may generally exhibit better elastic properties that cause less microyielding and less dissipation of vibrational energy. Therefore, the Q factors in the set of responses in the database may be compared with the Q factors in the set of responses from the BMG with unknown crystallinity. A best match may be identified based on a least-squares sense to database set. The crystallinity in the database corresponding to the identified set may be determined as the best estimate of the BMG's unknown crystallinity. The aforedescribed comparison can also be independently verified by a different method, such as a destruction method. For example, the evaluation/determination results can be compared to a differential scanning calorimetry (DSC) result.

In another example, a BMG may be subject to ultrasonic excitations at a plurality of frequencies. A set of resonance frequencies and/or Q factors may be determined based on the BMG's response. The set of resonance frequencies and/or Q factors may be compared against the set of resonance frequencies and/or Q factors having the same crystallinity in the database. FIG. 6 shows an example of a set 430 of resonance frequencies identified from the response of a BMG having a crystallinity percentage of 30% vol. The set 430 of resonance frequencies may be matched against the set in the database entries 410 corresponding to a crystallinity percentage of 30% vol. The example in FIG. 6 shows that the set 430 of resonance frequencies of the tested BMG has a different resonance frequency, e.g., 135 kHz, and missing resonance frequencies compared to the resonance frequencies in the database entries 410. The difference in the resonance frequencies, the absence of a resonance frequency, or some combination thereof may indicate that the tested BMG is defective. For example, the absence of a resonance frequency in a high part of the frequency range may indicate the presence of small cracks in the tested BMG that dampen its response to high-frequency excitations.

What is claimed:

1. A method, comprising:
providing a sample comprising a bulk amorphous alloy;
scanning ultrasonically at least a portion of the sample to determine a parameter of the sample in the portion; and
comparing the parameter to a predetermined standard to derive a property related to the sample.

2. The method of claim 1, wherein the sample is a part of an electronic device.

3. The method of claim 1, wherein the scanning is carried out by resonant ultrasonic spectroscopy.

4. The method of claim 1, wherein the portion is a single point or comprises substantially an entire surface of the sample.

5. The method of claim 1, wherein the portion comprises the bulk amorphous alloy.

6. The method of claim 1, wherein the parameter comprises at least one elastic constant.

7. The method of claim 1, wherein the property comprises presence of crystals, degree of crystallinity, Q factor, or combinations thereof.

8. The method of claim 1, wherein the standard is obtained from an alloy of a known degree of crystallinity and having a substantially same chemical composition as that of the bulk amorphous alloy.

9. The method of claim 1, further comprising evaluating the sample based on the property.

10. The method of claim 11, wherein the alloy comprises Zr, Hf, Ti, Cu, Ni, Pt, Pd, Fe, Mg, Au, La, Ag, Al, Mo, Nb, or combinations thereof.

11. The method of claim 1, further comprising:
making the sample;
and
evaluating the sample based on the parameter.

12. The method of claim 11, further comprising evaluating the making based on the property or the parameter.

13. The method of claim 11, further comprising modifying the making based on the evaluation.

14. The method of claim 11, wherein the making further comprises:
quenching a molten alloy charge to a temperature below a glass transition temperature of the alloy.

15. The method of claim 11, further comprising:
repeating the scanning and comparing at a different portion of the sample to obtain a plurality of properties related to the sample; and
comparing the plurality of properties.

16. A method, comprising:
obtaining at least one standard parameter from at least one standard alloy sample by scanning ultrasonically the at least one standard alloy sample;
obtaining a test parameter from a test alloy sample comprising a bulk amorphous alloy by scanning ultrasonically the test alloy sample; and
evaluating the test alloy sample by comparing the standard parameter with the test parameter.

17. The method of claim 16, further comprising determining the property independently by a destructive technique.

18. The method of claim 16, wherein the scanning further comprises applying a plurality of frequencies to the sample to measure resonance responses thereof.

19. The method of claim 16, wherein the method is automated.

20. The method of claim 16, wherein the test parameter and the standard parameter comprise at least one elastic constant.

21. An apparatus that is configured to carry out the method comprising:
scanning ultrasonically at least a portion of a sample comprising a bulk amorphous alloy to determine a parameter of the sample in the portion; and
comparing the parameter to a predetermined standard to derive a property related to the sample.

22. The apparatus of claim 21, comprising one or more transducers.

23. The apparatus of claim 21, wherein the apparatus is a part of a quality control feedback system.
